(19) United States
(12) Patent Application Publication
(10) Pub. No.: US 2008/0111002 A1
(43) Pub. Date: May 15, 2008

(54) SLEEVE FOR SUPPORTING A CYLINDER OF A CHOCOLATE FOUNTAIN

(76) Inventors: Richard B. Muir, San Diego, CA (US); William F. Polley, Marco Island, FL (US); Devan B. Muir, San Diego, CA (US); Wu C. Liang, Taoyuan City (TW)

Correspondence Address: KNOBBE MARTENS OLSON & BEAR LLP, 2040 MAIN STREET, FOURTEENTH FLOOR, IRVINE, CA, 92614, US

(21) Appl. No.: 11/558,381

(22) Filed: Nov. 9, 2006

(51) Int. Cl. E03B 9/20

(52) U.S. Cl. 239/16

(57) ABSTRACT

A chocolate fountain comprises a sleeve secured to a basin of the fountain, the sleeve having a central aperture sized to receive a lower portion of a cylinder so that the cylinder is supported by the sleeve. The sleeve may be attached to the basin by any means, such as via bolts that are integrally coupled to the sleeve. In this embodiment, a portion of the bolts extends through apertures in the basin and coupling devices, such as nuts, are attached to the bolts in order to secure the sleeve to the basin. Advantageously, the aperture of the sleeve is large enough to be easily cleaned and the cylinder does not comprise tubes welded on the side of the cylinder as in currently available chocolate fountains.

### BACKGROUND OF THE INVENTION

1. Field of the Invention

The invention relates generally to a food dispensing apparatus, and more particularly to a fountain that flows with a fluidic material.

2. Description of the Related Art

Fondue machines typically include a bowl shaped container for holding and heating a medium; usually, an edible medium, such as chocolate, cheese, or caramel. For ease of description, in the following description of various embodiments of fondue machines and fountains, chocolate will be the medium that is heated. However, those of skill in the art will recognize that a reference to chocolate hereinafter may be replaced by any other medium. The container of a typical fondue machine is heated by a heating element to melt the chocolate. Fruit, or other food items, may then be dipped into the container of the fondue machine.

In recent years, fondue machines have taken on alternate configurations. For example, a fondue fountain has been developed that moves melted chocolate, cheese, or caramel, for example, so that the melted medium flows over a number of tiers like a fountain. FIG. 1 is a diagram illustrating a prior art chocolate fountain 100, including a container 110 configured to hold and melt chocolate. A hollow barrel 120 is mounted in the center of the container 110 and provides a pathway for melted chocolate to be moved upward, through its hollow center, to the top of the fountain. An auger including a spiral flight extending around the length of the auger is mounted within the hollow barrel 120. The auger is rotated in order to lift the melted chocolate upward in the hollow barrel 120. On the top of the barrel 120 is a crown 140 that fills with chocolate that flows out of the barrel 120. When the crown 140 is full of melted chocolate, the chocolate begins to fall over the edges of the crown 140. Attached to the barrel 120 are tiers 130 which vary in size. As the chocolate flows downwardly from the crown 140, the chocolate flows over each of the tiers 130, thus forming a multi-level chocolate waterfall. The chocolate fountain 100 also includes a heating element that is placed below the container 1 10.

### SUMMARY OF THE INVENTION

In one embodiment, a fountain for circulating a fluidic material comprises a basin having a top surface and a bottom surface, the top surface being configured to contact the fluidic material and the bottom surface contacting a support structure, the basin being configured to contain the fluidic material, wherein the basin comprises at least one aperture in a central portion of the basin, a collar comprising an aperture and at least one post extending from the collar, the at least one post being sized to fit through the at least one aperture in the central portion of the basin such that at least a portion of the post extends from the bottom surface of the basin, a cylinder having a top end and a bottom end, wherein the bottom end is sized to be received by the aperture of the collar such that the cylinder is stabilized by the sleeve and the stabilized cylinder extends upwardly substantially perpendicular to the central portion of the basin, an auger having a spiral flight comprising a plurality of revolutions protruding along a length of the auger, wherein the auger is disposed within the cylinder, a tier removably attached to the cylinder and having an upper surface and a lower surface, and a source of rotation coupled to the auger and configured to rotate the auger inside the cylinder, wherein the spiral flight supports the fluidic material as the auger rotates, moving the fluidic material upwardly to the top end of the cylinder.

In another embodiment, a method of assembling a fountain comprises positioning a sleeve on a basin, the sleeve comprising an aperture and at least one post extending from a bottom surface of the sleeve, the at least one post being sized to fit through an aperture in a central portion of the basin such that a threaded portion of the post extends from a bottom surface of the basin, tightening a nut onto the threaded portion of the post so that the sleeve is secured to the basin, and inserting a bottom end of a cylinder into the aperture of the sleeve such that the cylinder is stabilized by the sleeve and the stabilized cylinder extends upwardly substantially perpendicular to the central portion of the basin.

In another embodiment, an apparatus comprises a basin having a top surface and a bottom surface, the top surface being configured to contact fluidic material and the bottom surface contacting a support structure, the basin being configured to contain the fluidic material, a sleeve comprising a body having a central aperture, the sleeve further comprising one or more attachment members coupled to the body, the sleeve being attached to the basin via the attachment members so as to define a space between the top surface of the basin and the body, and a cylinder having a top end and a bottom end, wherein the bottom end is sized to be received by the central aperture of the sleeve such that the cylinder is stabilized by the sleeve and the stabilized cylinder extends upwardly substantially perpendicular to the central portion of the basin.

### BRIEF DESCRIPTION OF THE DRAWINGS

FIG. 1 is a side elevation view of a prior art chocolate fountain.

FIG. 2 is a cross-sectional side view of another embodiment of a chocolate fountain.

FIG. 3A illustrates a lower portion of a cylinder having attachment tubes coupled to the cylinder.

FIG. 3B illustrates the cylinder of FIG. 3A mounted on posts extending from a bottom surface of a basin.

FIG. 4A illustrates an exemplary cylinder positioned above a basin, the basin having a sleeve mounted to a bottom portion of the basin.

FIG. 4B illustrates a cross-sectional side view of a bottom portion of a first embodiment of a cylinder.

FIG. 4C illustrates a cross-sectional side view of a bottom portion of a second embodiment of a cylinder.

FIG. 4D illustrates an isometric side view of a bottom portion of the cylinder of FIG. 4B.

FIG. 4E illustrates an isometric side view of a bottom portion of the cylinder of FIG. 4C.

FIG. 5 illustrates a perspective view of a portion of the sleeve illustrated in FIG. 4A, the sleeve comprising an alignment notch that is configured to engage with a protrusion on the cylinder.

FIG. 6 illustrates a first embodiment of a top view of the sleeve of FIG. 5.

FIG. 6A illustrates a cross-sectional side view of the sleeve of FIG. 6 taken across line A-A.

FIG. 6B illustrates cross-sectional side view of a first embodiment of the sleeve of FIG. 6 taken along line B-B.

FIG. 6C illustrates a cross-sectional side view of a second embodiment of a sleeve.

FIG. 7 illustrates a cross-sectional side view of an embodiment of a sleeve attached to a bottom portion of a basin.

FIG. 8 is a cross-sectional side elevation view of another embodiment of a chocolate fountain.

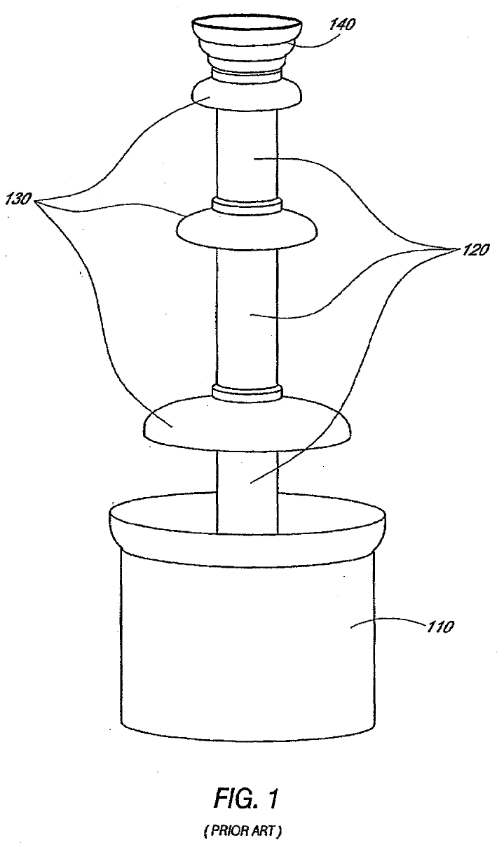

### DETAILED DESCRIPTION OF THE PREFERRED EMBODIMENT

Embodiments of the invention will now be described with reference to the accompanying Figures, wherein like numerals refer to like elements throughout. The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

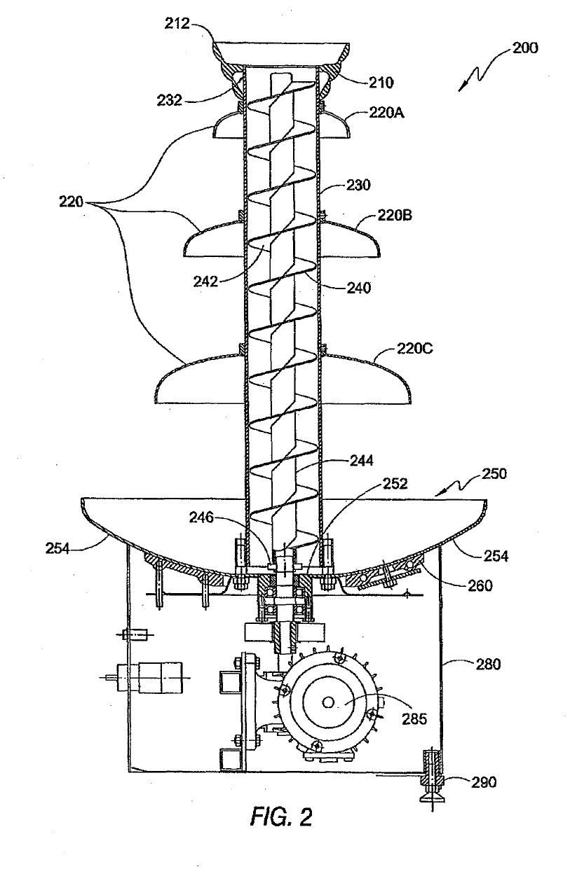

FIG. 2 is a cross-sectional side view of one embodiment of a fondue fountain 200 (or simply “fountain 200”). In one embodiment, the fountain 200 flows with melted chocolate, or other medium, that may be heated by a heating element 260 of the fountain 200. While reference is made herein to the use of chocolate in the fountain 200, the systems and methods described herein are not limited to the use of chocolate. Accordingly, references made herein to a chocolate fountain do not limit the fountain to use with chocolate. In particular, any other fluidic material which a user wishes to circulate through the fountain 200 may be used instead of chocolate. For example, other confectionery items, such as caramel, toffee, taffy, or marshmallows; dairy products, such as cheese; or flavorings, such as mint or fruit, may be used in the fountain 200. Additionally, different varieties of chocolate, such as white chocolate, dark chocolate, or milk chocolate, may be used in the fountain 200. Furthermore, any combination of food items, such as a combination of chocolate and caramel, for example, may be used in the fountain 200 or any of the other fountains described hereinafter, such as the fountain of FIG. 8, for example.

As shown in FIG. 2, the chocolate fountain 200 comprises a housing 280, upon which a basin 250 is mounted. The housing 280 houses a motor 285 and heating elements 260. The motor 285 may be any type of motor suitable to provide a rotary force. As described in further detail below, the heating element 260 is preferably maintained in contact with the basin 260 and may be encased in an aluminum enclosure in order to more uniformly distribute the heat throughout the basin 250. Accordingly, the chocolate is substantially uniformly heated and melted in the basin 250 due to the uniform heating of the basin 250 by the heating element 260. In other embodiments, however, the fountain 200 may not include a heating element 260 and may even include a cooling element positioned so as to cool the contents of the basin 250.

In the embodiment of FIG. 2, an auger 240 having a spiral flight 242 surrounding a central shaft 244 of the auger 240 is coupled to the bottom surface 252 of the basin 250. In this embodiment, the motor 285 engages the auger 240 and applies a rotational force causing the auger 240 to rotate and thereby to lift melted chocolate, for example, upward inside the cylinder 230, the chocolate traveling upwardly upon the top surface of the spiral flight 242. In the embodiment of FIG. 2, a crown 210 is mounted on a top 232 of the cylinder 230 and provides an exit location for the melted chocolate that has been lifted through the cylinder 230, wherein the melted chocolate flows over a top circumference 212 of the crown 210. In this embodiment, an adjustment nut 290 is connected to the housing 280 and allows adjustment of the height of the foot so that the fountain 200 may be leveled.

In the embodiment of FIG. 2, the chocolate fountain 200 includes tiers 220 that are each attached to the cylinder 230. In other embodiments, any number of tiers 220, such as 1, 2, 4, 5, or 6, for example, may be attached to the cylinder 230. A top surface of each of the tiers 220 comes in contact with the melted chocolate that flows off the top circumference 212 of the crown 210 so that the melted chocolate flows over each of the tiers 220 and returns to the basin 250. In this way, the chocolate continues to circulate through the chocolate fountain 200 and creates levels of chocolate flowing like a waterfall.

In one embodiment, the basin 250 has a bottom surface 252 and sides 254 which are configured to hold a fluidic material. Advantageously, the basin 250 is shaped so that the fluidic material flows towards the center of the basin 250 and is available to circulate up the cylinder 230 on the auger 240. In particular, the angle between the bottom surface 252 and the sides 254 is sufficiently large so that the melted chocolate flows towards the bottom surface 252 and the cylinder 230. Accordingly, because of the shape of the basin 250, pooling of melted chocolate on the bottom surface 252 is reduced and substantially all of the melted chocolate circulates through the fountain at a uniform rate. Because substantially all of the chocolate circulates through the fountain 200 at a uniform rate, the chocolate is more uniformly heated as it flows across the bottom surface 252 of the basin 250.

An auger 240 having a spiral flight 242 surrounding a central shaft of the auger 240 is coupled to the bottom surface 252 of the basin 250. A bottom end of the shaft 244 includes a connecting means configured to connect the shaft 244 with the motor 285 so that the motor 285 rotates the auger 240. In the embodiment of FIG. 2, the connecting means comprises a cross-rod 246 or other mechanical means to connect the drive that connects with a gear driven by the motor 285. In one embodiment, the diameter of the auger 240, measured from the outer ends of the spiral flight 242, is substantially equal to the inner diameter of the cylinder 230. Thus, the auger 240 fits snuggly within the cylinder 230. As the motor 285 provides a rotational force causing the auger 240 to rotate, melted chocolate, for example, in the basin 250 is moved upwardly along the length of the cylinder 230, traveling upon the top surface of the spiral flight 242.

Exemplary chocolate fountain 200 includes three tiers 220 that are each attached to the cylinder 230. A top surface of each of the tiers 220 comes in contact with the melted chocolate that flows off the top circumference 212 of the crown 210 so that the melted chocolate flows over each of the tiers 220 and returns to the basin 250. More particularly, after the melted chocolate flows over the top circumference 212 of the crown 210, the chocolate drops to the top surface of the upper tier 220A. The melted chocolate then flows to an outer perimeter of the upper tier 220A and drops to a lower tier 220B. The melted chocolate next flows to an outside perimeter of lower tier 220B and drops to a base tier 220C. The melted chocolate then flows off of the base tier 220C and returns to the basin 250. The returning melted chocolate flows with the other melted chocolate in the basin 250 and returns to the bottom surface 252 of the basin so that it may again be heated and lifted through the cylinder 230 by the auger 240. In this way, the chocolate continues to circulate through the chocolate fountain 200 and creates levels of chocolate flowing like a waterfall. The tiers 220 may be coupled to the cylinder 230 in various manners.

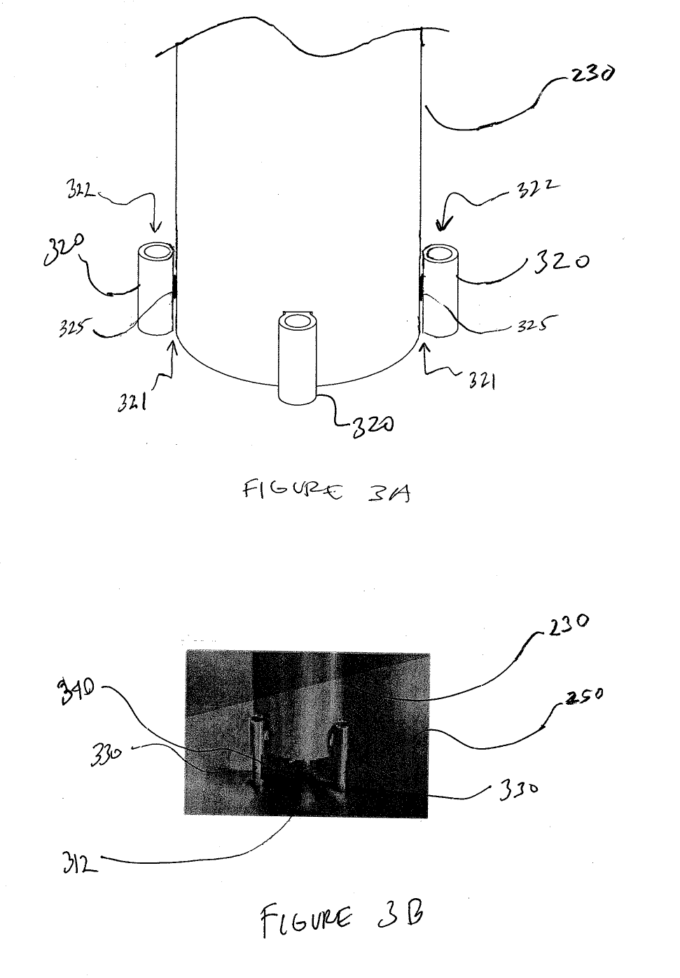

FIG. 3A illustrates a lower portion of the cylinder 230 having attachment tubes 320 coupled to the lower exterior surface of the cylinder 230. In the embodiment of FIG. 3A, the cylinder 230 is coupled to an inner portion of a basin, such as basin 250 (FIG. 2) when longitudinal posts that extend upward from a top surface of the basin are inserted into the tubes 320. For example, FIG. 3B illustrates the cylinder 230 mounted on posts 330 extending from the top surface 350 of the basin 250 (FIG. 2). More particularly, the posts 330 are inserted through at least a portion of respective tubes 320 such that the cylinder 230 is removably attached to the basin 250. As illustrated in FIG. 3B, the posts 330 are configured for only partial insertion through the tubes 320, such that a space 340 between the lower edge 312 of the cylinder 230 and the basin 250 is created. This space 340 allows the melted chocolate, or other fluidic material, to flow underneath the cylinder 230 so that the chocolate may engage with the auger 240 (FIG. 2; Not shown in FIG. 3B) and be lifted upward through the cylinder 230.

While the posts 330 and tubes 320 provide adequate structural support for the cylinder 230, these components comprises multiple portions that are difficult to clean and are prone to collect chocolate as the fountain 200 operates. More particularly, as shown in FIG. 3A, the tubes 320 are attached to the cylinder via weld junctions 325. Thus, crevices 321 are created between the tubes 320 and the cylinder 230 around the weld junctions 325. These crevices 325 are typically very narrow, such as less than 1-5 mm, and are, therefore, difficult to clean. Additionally, the tunnels 322 through the center of the tubes 320 can be very narrow and, therefore, difficult to keep clean. With the difficulty of cleaning both the crevices 321 and the tunnels 322, adequate sanitization of the cylinder 230 is laborious and difficult to achieve. Furthermore, the cylinder 230 having the crevices 321 and the tunnels 322 may not reach the sanitation levels required by sanitation agencies, such as the National Sanitation Foundation (“NSF”) and, therefore, may not be eligible for NSF certification.

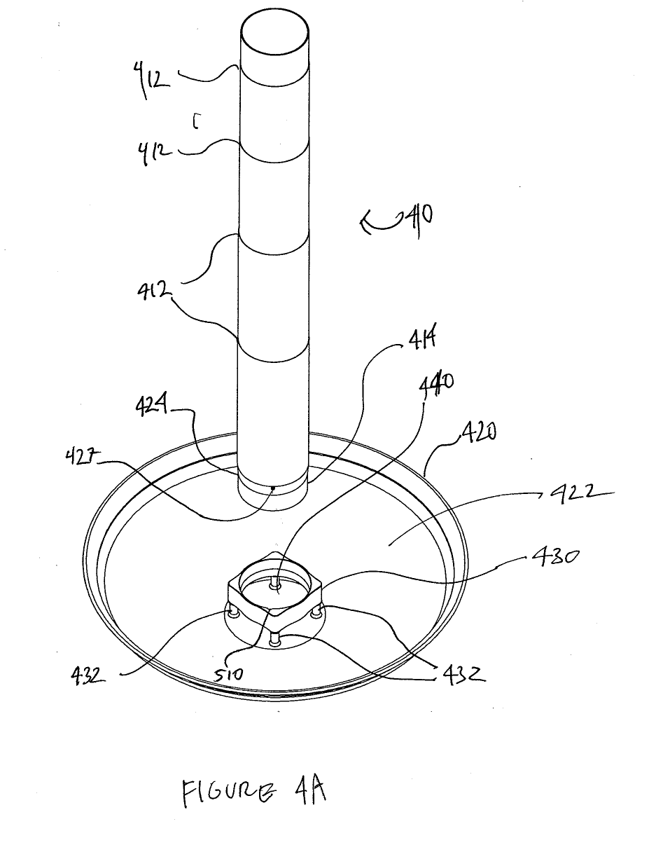

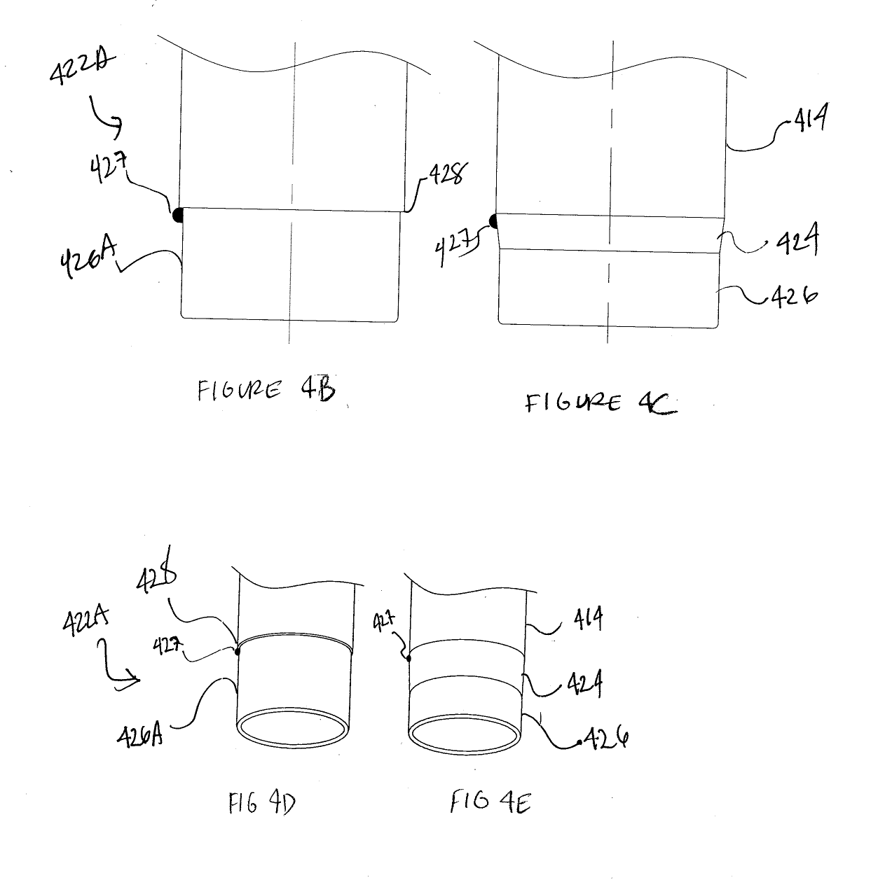

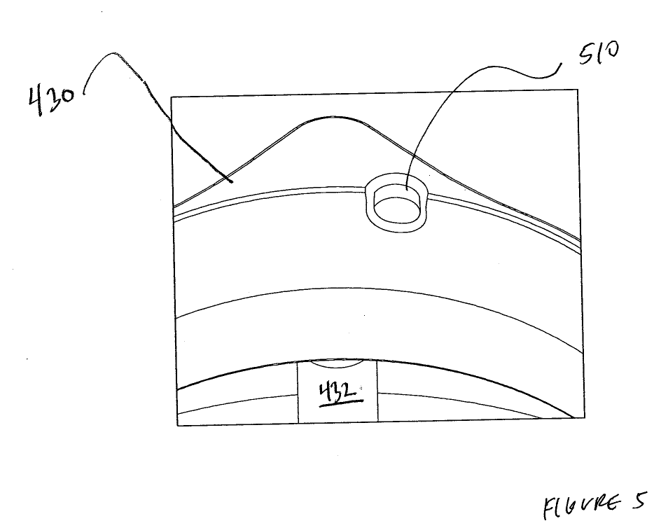

FIG. 4A illustrates another embodiment of a cylinder 410 positioned above a basin 420 having a sleeve 430 mounted to a central portion 422 of the basin 420. As described further below, the cylinder 410 and the sleeve 430 advantageously comprise only large openings that are easily cleaned and sanitized. In the illustration of FIG. 4A, the cylinder 410 has not yet been coupled to the basin 420, but is positioned above the basin 420. The cylinder 410 may be attached to, and supported by, the basin 420 via the sleeve 430 (that is attached to the basin 420) by lowering the cylinder 410 into a central aperture 440 of the sleeve 430.

In the embodiment of FIG. 4A, the cylinder 410 comprises a plurality of steps 412 (also referred to as ledges 412). In one embodiment, the steps 412 are configured to support tiers that are placed on the cylinder 410. For example, a tier, such as tiers 220 (FIG. 2), may be placed so that the cylinder 410 extends through a central aperture of the tier. In one embodiment, the central aperture is sized to be supported by one of the steps 412. In one embodiment, apertures in different tiers are sized differently such that each of the tiers is supported on a different step 412.

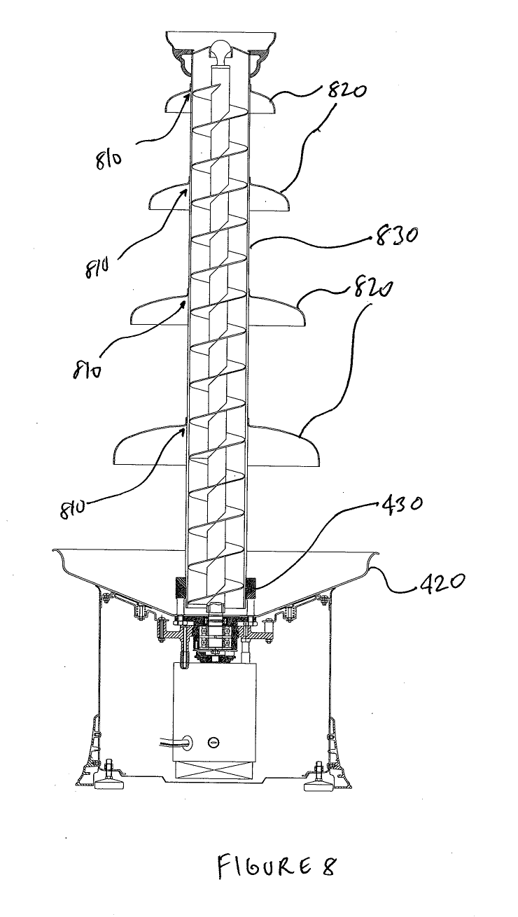

In the embodiment of FIG. 4A, the sleeve 430 is mounted to the central portion 422 of the basin 420 by four posts 432 that partially extend through the central portion 422 of the basin 420 such that a threaded portion of the posts 432 extends from a bottom surface 720 (FIG. 7) of the basin 420. Thus, a nut, or other threaded coupling means, may be attached to this threaded portion in order to secure the sleeve 430 to the basin 420. FIG. 7, which is discussed in further detail below, illustrates a cross-sectional detail of the sleeve 430 attached to the basin 420. As shown in FIG. 4A, the sleeve 430 comprises a central aperture 440 sized to engage a lower portion 414 of the cylinder 410. In one embodiment, the diameter of the central aperture 440 is substantially the same as an outer diameter of the lower portion 414 such that the lower portion 414 snugly fits into the central aperture 440 and the cylinder 410 is supported by the sleeve 430.

In the embodiment of FIG. 4A, the bottom portion 414 of the cylinder comprises a tapered portion 424. FIG. 4C illustrates a cross-sectional side view, and FIG. 4E illustrates an isometric side view, of the bottom portion 414 having the tapered portion 424 and a non-tapered portion 426. In this embodiment, the portion 426 is sized to fit within the central aperture 440 of the sleeve 430. The tapered portion 424 increases a diameter of the cylinder 410 such that the tapered portion 424 engages with the sleeve 430 and the cylinder 410 is supported by the sleeve 430.

FIG. 4B illustrates a cross-sectional side view, and FIG. 4D illustrates an isometric side view, of a bottom portion 422A of a cylinder. In this embodiment, the cylinder comprises step 428 and a portion 426A that is sized to fit within the central aperture 440 of the sleeve 430. The step 428 is sized larger that the portion 426A such that the step 428 rests on the wall surrounding the central aperture 440 in order to support the cylinder on the sleeve 430.

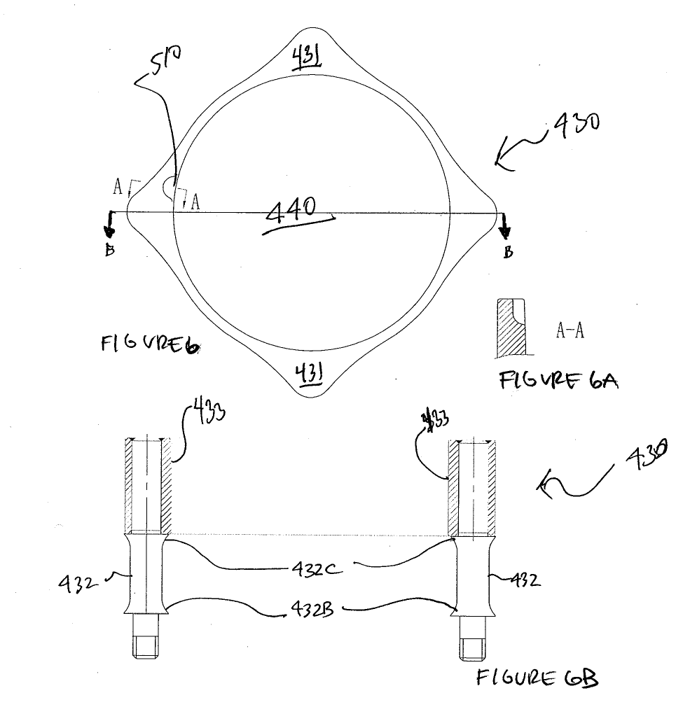

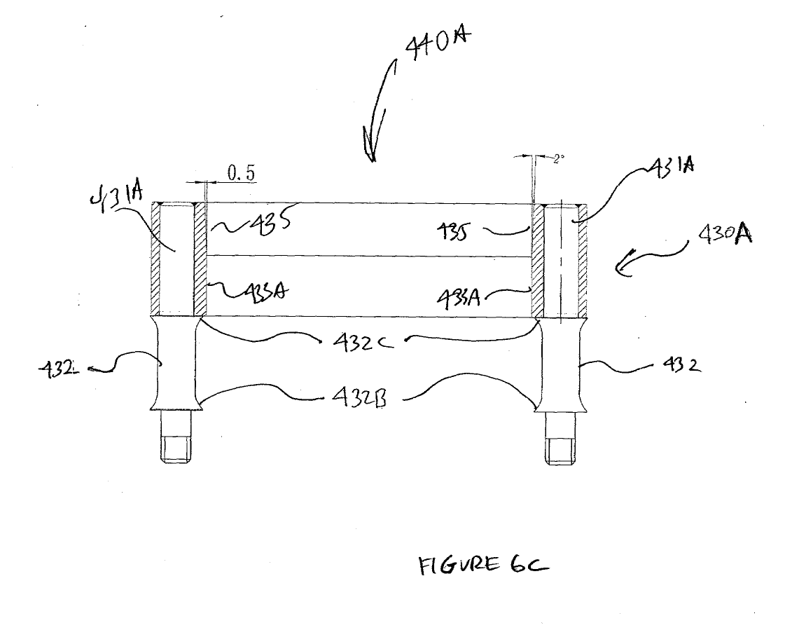

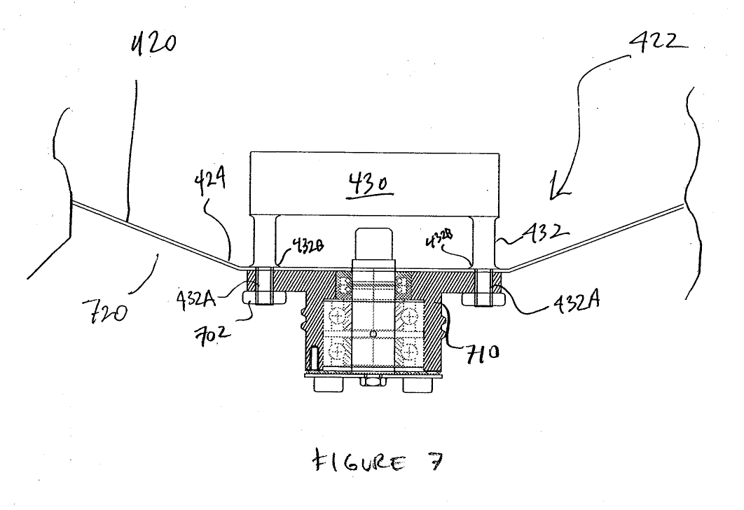

FIG. 5 illustrates a portion of the sleeve 430 comprising an alignment notch 510 (Illustrated in FIGS. 4A and 6, also) that is sized to engage with a protrusion 427 (FIGS. 4A, 4B, 4C, 4D, 4E) on the cylinder (FIGS. 4A, 4B, 4C, 4D, 4E). In this embodiment, the cylinder may be prevented from rotating by engaging the protrusion 427 on the cylinder with the alignment notch 510. In other embodiments, the cylinder does not comprise a protrusion 427 and the sleeve 430 does not comprise an alignment notch 510.

FIG. 6 illustrates a top view of a first embodiment of the sleeve 430 and FIG. 6B illustrates a cross-sectional side view of the sleeve 430 taken across line B-B. As shown in FIG. 6, the sleeve 430 comprises a body 431 having a circular central aperture 440 that is sized to receive a portion of the cylinder, such as the portion 426 (FIGS. 4C, 4E) or portion 426A (FIGS. 4B, 4D). FIG. 6B illustrates an inner surface 433 of the body 431, where the inner surface 433 defines the perimeter of the central aperture 440. Advantageously, the central aperture 440 is sized large enough for easy cleaning and sanitization. In the embodiment of FIG. 6, the sleeve 430 also comprises an alignment notch 510 that is illustrated in FIG. 6A, which is a cross-sectional side view of FIG. 6 taken across line A-A.

As illustrated in FIGS. 6B and 6C, the posts 432 comprise tapered portions 432B and 432C. The tapered portion 432C is adjacent the body 431 of the sleeve 430 and advantageously makes the junction between the posts 432 and the body 431 smooth and, therefore, easier to clean. In contrast, in an embodiment where the posts 432 do not comprise tapered portions adjacent the junction with the body, the angle between the posts 432 and the body would be about ninety degrees, would not be smooth, and may be difficult to clean and sanitize. Accordingly, the posts 432 advantageously comprise tapered portion 432C that provide a smooth internal junction between the posts 432 and the body 431. In one embodiment, the junction between the posts 432 and the body 431 has a minimum continuous radii of ⅛ inch.

In the embodiments of FIGS. 6B and 6C, the tapered portions 432B are adjacent the basin 420 when the sleeve 430 is attached to the basin 420. Similar to the tapered portions 432C, the tapered portions 432B advantageously make the junction between the posts 432 and the body 431 easier to clean because there are no large angles. In one embodiment, tapered portions 432B are configured such that when the sleeve 430 is mounted on the basin 420, a smooth internal junction (between the posts 432 and the basin 420) having a minimum continuous radii of ⅛ inch is created.

As noted above, in one embodiment the cylinder comprises a step 428 (FIGS. 4B, 4D) or a tapered portion (FIGS. 4C, 4E) that is larger that the central aperture 440. Accordingly, the step (for example, step 428 of FIG. 4B) or tapered portion (for example, tapered portion 424 of FIG. 4C) engages with the body 431 of the sleeve 430 such that the cylinder is supported by the sleeve 430. In an advantageous embodiment, the central aperture 440 is sized so that the portion 426, 426A of the cylinder is friction fit against the inner surfaces 433 of the body 431. Thus, the portions 426, 426A that are received within the aperture 440 are held in a stationary position so that the remainder of the cylinder that extends upward and away from the sleeve 430 is substantially free of lateral movement.

FIG. 6C illustrates a second embodiment of a cross-sectional side view of a sleeve 430A, wherein a portion 435 of the inner surface 433A of the body 431A is tapered away from a center of the central aperture 440A so that a diameter of the aperture 440A at the top of the portion 435 is larger than a diameter of the aperture 440A at the bottom of the portion 435. In the exemplary embodiment of FIG. 6C, the tapered portion 435 is slanted inward at an angle of about 2 degrees from the inner surface 433A of the body 431A. In other embodiments, the taper angle may be less or greater than 2 degrees, such as 0.5, 1, 2.5, 3, 5, or 5 degrees, for example. In the embodiment of FIGS. 6C, the tapered portion 435 may increases a friction fit between the portions 426 or 426A of the cylinder.

FIG. 7 illustrates a cross-sectional side view of an embodiment of the sleeve 430 attached to a central portion 422 of the basin 420. As illustrated in FIG. 7, tapered portions 432B of the posts 432 abut a top surface 424 of the basin 420 such that the posts 432 are supported on the top surface 424. A threaded portion 432A of the posts 432 extends through the basin 420 so that a nut 702, such as a hex nut or wing nut, may be attached to the threaded portion 432A in order to secure the sleeve 430 to the basin 422. In the embodiment of FIG. 7, the threaded portion 432A extends through a portion of the housing 710 that may house internal components of the fountain, such as a motor. In other embodiments, the threaded portion 432A extends only through the basin 420, such that the nuts 702 are tightened against a bottom surface 720 of the basin 422. In one embodiment, one or more washers are positioned between the nuts 702 and the lower surface 720.

FIG. 8 is a cross-sectional side elevation view of another embodiment of a chocolate fountain 800. In the embodiment of FIG. 8, the fountain 800 comprises the sleeve 430 secured to the basin 420. The cylinder 830 comprises steps 810 configured to support respective tiers 820. In this embodiment, an aperture of the sleeve 430 has received a lower portion of the cylinder 830 so that the cylinder 830 is supported by the sleeve 430. Advantageously, the aperture of the sleeve 430, shown in FIG. 4A as aperture 440, is large enough to be easily cleaned. Additionally, the aperture 440 is large enough so that the fountain, including the sleeve 430 and the cylinder 830 may be NSF certified.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

What is claimed is:

1. A fountain for circulating a fluidic material, the fountain comprising:
a basin having a top surface and a bottom surface, the top surface being configured to contact the fluidic material and the bottom surface contacting a support structure, the basin being configured to contain the fluidic material, wherein the basin comprises at least one aperture in a central portion of the basin;
a collar comprising an aperture and at least one post extending from the collar, the at least one post being sized to fit through the at least one aperture in the central portion of the basin such that at least a portion of the post extends from the bottom surface of the basin;
a cylinder having a top end and a bottom end, wherein the bottom end is sized to be received by the aperture of the collar such that the cylinder is stabilized by the sleeve and the stabilized cylinder extends upwardly substantially perpendicular to the central portion of the basin;
an auger having a spiral flight comprising a plurality of revolutions protruding along a length of the auger, wherein the auger is disposed within the cylinder;
a tier removably attached to the cylinder and having an upper surface and a lower surface; and
a source of rotation coupled to the auger and configured to rotate the auger inside the cylinder, wherein the spiral flight supports the fluidic material as the auger rotates, moving the fluidic material upwardly to the top end of the cylinder.

2. The fountain of claim 1, wherein the basin comprises four apertures in the central portion of the basin and the sleeve comprises four posts sized to be extended through respective apertures in the central portion of the basin.

3. The fountain of claim 2, wherein the posts comprise a tapered portion that is configured to engage with the top surface of the basin and support the sleeve on the basin.

4. The fountain of claim 1, wherein the portion of the post that extends from the bottom surface of the basin is threaded, the fountain further comprising a nut having internal threads sized to engage with the threaded portion of the post.

5. The fountain of claim 1, further comprising a plurality of tiers, each having a central aperture with a different diameter, wherein the cylinder is step tapered so that each of the plurality of tiers engages with one of the step-tapers when the tiers are lowered around the cylinder.

6. The fountain of claim 1, wherein the cylinder comprises a first external diameter at a first location and a second external diameter larger than the first external diameter at a second location that is below the first location so as to define a step sized to support the tier, wherein the tier comprises an aperture with a diameter that is substantially equal to the first external diameter.

7. The fountain of claim 1, further comprising a crown mounted on a top end of the cylinder, wherein the chocolate flows from the top end of the cylinder onto the crown and then onto the upper surface of the tier.

8. The fountain of claim 1, wherein the fluidic material comprises melted chocolate.

9. A method of assembling a fountain, the method comprising:
positioning a sleeve on a basin, the sleeve comprising an aperture and at least one post extending from a bottom surface of the sleeve, the at least one post being sized to fit through an aperture in a central portion of the basin such that a threaded portion of the post extends from a bottom surface of the basin;
tightening a nut onto the threaded portion of the post so that the sleeve is secured to the basin; and
inserting a bottom end of a cylinder into the aperture of the sleeve such that the cylinder is stabilized by the sleeve and the stabilized cylinder extends upwardly substantially perpendicular to the central portion of the basin.

10. The method of claim 9, further comprising:
lowering a tier onto the cylinder until the tier engages a step of the cylinder, the step being sized to support the tier on the cylinder.

11. The method of claim 9, wherein the post comprises a tapered portion that is configured to engage with a top surface of the basin and support the sleeve on the basin.

12. The method of claim 9, further comprising positioning an auger within the cylinder, the auger being configured to lift a fluidic material upward within the cylinder.

13. The method of claim 12, wherein the fluidic material comprises melted chocolate.

14. An apparatus comprising:
a basin having a top surface and a bottom surface, the top surface being configured to contact fluidic material and the bottom surface contacting a support structure, the basin being configured to contain the fluidic material;
a sleeve comprising a body having a central aperture, the sleeve further comprising one or more attachment members coupled to the body, the sleeve being attached to the basin via the attachment members so as to define a space between the top surface of the basin and the body; and
a cylinder having a top end and a bottom end, wherein the bottom end is sized to be received by the central aperture of the sleeve such that the cylinder is stabilized by the sleeve and the stabilized cylinder extends upwardly substantially perpendicular to the central portion of the basin.

15. The apparatus of claim 14, wherein the attachment members each comprise a threaded portion that extends through respective apertures in the basin.

16. The apparatus of claim 14, wherein the sleeve comprises a single structure that is free of welding artifacts.

17. The apparatus of claim 14, wherein the bottom end of the cylinder comprises a step configured to engage with a top surface of the sleeve body.

18. The apparatus of claim 14, wherein the bottom end of the cylinder comprises a tapered portion configured to provide a friction fit with the sleeve body as the tapered portion is received into the central aperture.

19. The apparatus of claim 14, wherein the fluidic material flows through the space between the top surface of the basin and the sleeve body.

20. The apparatus of claim 14, wherein the fluidic material comprises melted chocolate.

21. The apparatus of claim 14, wherein a junction between the attachment members and the body is substantially smooth.

22. The apparatus of claim 21, wherein the junction has a minimum continuous radii of ⅛ inch.
